(19) United States
(12) Patent Application Publication
(10) Pub. No.: US 2026/0336681 A1
(43) Pub. Date: Oct. 29, 2026

(54) HANDS OFF DETECTION SENSOR OF STEERING WHEEL

(71) Applicant: GENTHERM GMBH, Odeizhausen (DE)

(72) Inventors: Jan BESKA, Tecumseh (CA); Zoran PANIC, Windsor (CA)

(21) Appl. No.: 19/117,840

(22) PCT Filed: Oct. 31, 2023
(86) PCT No.: PCT/US2023/036340

§ 371 Date: Apr. 2, 2025

Related U.S. Application Data
(60) Provisional application No. 63/428,265, filed on Nov. 28, 2022.

(51) Int. Cl. B62D 1/04; B62D 1/06; G01L 1/14; G01L 5/22; H05B 3/36

(52) U.S. Cl. CPC B62D 1/046; B62D 1/065; G01L 1/142; G01L 5/221; H05B 3/36; H05B 2203/003

(57) ABSTRACT

A hands off detection (HOD) sensor of a steering wheel of a vehicle includes: an electrically insulative substrate (308) having a first surface and a second surface that is opposite the first surface; a first metal layer (304) disposed on the first surface of the electrically insulative substrate; and a first electrical conductor (340) having a first end that is directly electrically connected to the first metal layer, where the first metal layer is attached to the first surface of the electrically insulative substrate without an adhesive.

### CROSS-REFERENCE TO RELATED APPLICATIONS

The present disclosure is a PCT International Application which claims the benefit of United States Provisional Patent Application No. 63/428,265 filed on Nov. 28, 2022. The entire disclosure of the application referenced above is incorporated herein by reference.

### FIELD

The present disclosure relates to steering wheels and more particularly to hands off detection sensors of steering wheels of vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In some vehicles, steering wheels comprise heaters to heat the steering wheels. In addition, the steering wheels can comprise hands-on detection sensors (e.g., capacitive sensors) to sense whether or not an occupant's hand or hands are on the steering wheel of the vehicle. For example, in partially autonomous vehicles, while an autonomous control system automatically controls driving of the vehicle under some conditions, some situations may require a driver to intervene and/or take control of the vehicle. For example, while driving on a highway may be handled by the autonomous control system, driver intervention may be requested in the event of an accident or construction on the roadway or when the autonomous system cannot function. Using the hands-on detection sensors in the steering wheels, the vehicles can sense whether or not an occupant's hand or hands are on the steering wheel prior to disengaging the autonomous control system.

### SUMMARY

In a feature, a hands off detection (HOD) sensor of a steering wheel of a vehicle is described and includes: an electrically insulative substrate having a first surface and a second surface that is opposite the first surface; a first metal layer disposed on the first surface of the electrically insulative substrate; and a first electrical conductor having a first end that is directly electrically connected to the first metal layer, where the first metal layer is attached to the first surface of the electrically insulative substrate without an adhesive.

In further features, the first metal layer is a first metal film layer.

In further features, a second metal film layer is disposed on the second surface of the electrically insulative substrate; and a second electrical conductor Ha a first end that is directly electrically connected to the second metal film layer.

In further features, the first and second metal film layers are layers of aluminum film In further features, the first and second metal film layers are layers of copper film.

In further features, the electrically insulative substrate includes one of polyester, polyurethane, and a polymer film.

In further features, a plurality of apertures extend through the electrically insulative substrate, the first metal film layer, and the second metal film layer.

In further features, the apertures all have the same size.

In further features, the apertures include at least two different sizes.

In further features, the apertures all have the same shape.

In further features, the apertures include at least two different shapes.

In further features, spacing between adjacent ones of the apertures is the same.

In further features, spacing between adjacent ones of the apertures includes at least two different spacings.

In further features, the first end of the first electrical conductor is adhered to the first metal film layer and the first end of the second electrical conductor is adhered to the second metal film layer.

In further features, one of electrically conductive adhesive and electrically conductive glue is included that adheres the first end of the first electrical conductor to the first metal film layer and the first end of the second electrical conductor is adhered to the second metal film layer.

In further features, a first thickness of the first metal film layer and a second thickness of the second metal film layer are less than a third thickness of the electrically insulative substrate.

In further features, the first and second thicknesses are less than 2 micrometers.

In further features, the first and second thicknesses are less than 1 micrometer.

In further features, the first and second thicknesses are less than 0.5 micrometers.

In further features, the first metal film layer and the second metal film layer are deposited on the electrically insulative substrate using vapor deposition.

In further features, the vapor deposition is physical vapor deposition.

In a feature, a steering wheel includes: the HOD sensor; and an electric heater, where the second metal film layer is disposed radially between the first metal film layer and the electric heater.

In further features, an electrical insulator is disposed between the second metal film layer and the electric heater.

In further features, the electrical insulator is a foam.

In further features a system includes: the HOD sensor; and a hands off module configured to: electrically connect to second ends of the first and second electrical conductors; and detect when a driver's hands are off of the steering wheel based on a capacitance between the first and second metal film layers.

In further features, the first and second electrical conductors are insulated electrical conductors.

In a feature, a hands off detection (HOD) sensor of a steering wheel of a vehicle includes: an electrically insulative substrate having a first surface and a second surface that is opposite the first surface; a first metal layer disposed on the first surface of the electrically insulative substrate; and a second metal layer disposed on the second surface of the electrically insulative substrate, where each of the first metal layer and the second metal layer includes: a second electrically insulative substrate having a third surface and a fourth surface that is opposite the third surface; a first metal film layer disposed on the third surface; and a second metal film layer disposed on the fourth surface.

In further features, a first thickness of the second electrically insulative substrate is greater than a second thickness of the first metal film layer and greater than a third thickness of the second metal film layer.

In further features, the first metal film layer and the second metal film layer are deposited on the second electrically insulative substrate using vapor deposition.

In further features, the vapor deposition is physical vapor deposition.

In further features, linear slits are through the first electrically insulative substrate, the first metal layer, and the second metal layer.

In further features, the linear slits are arranged in a V-shape.

In further features, the linear slits include first rows of linear slits that are parallel and second rows of linear slits that form orthogonal angles with the linear slits of the first rows.

In further features, a first thickness of the a second electrically insulative substrate is greater than a second thickness of the first metal film layer and a third thickness of the second metal film layer.

In further features, the second electrically insulative substrate is made of polyester, and the first and second metal film layers include aluminum.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example of a steering wheel of a vehicle;

FIG. 2 is an exploded perspective view of a heater and a hands off detection (HOD) sensor before application to a steering wheel;

FIG. 3 includes an exploded perspective view of the HOD sensor;

FIG. 4 includes a cross-sectional view of the HOD sensor;

FIG. 5 is a perspective view of an example implementation of the HOD sensor 208 from a point of view toward a sensor metal film layer;

FIG. 6 is a close up perspective view of apertures through the HOD sensor;

FIG. 7 is another perspective view of an example implementation of the HOD sensor from a point of view toward a sensor metal film layer;

FIG. 8 includes a cross-sectional view of an example portion of the steering wheel;

FIG. 9 is a functional block diagram of an example vehicle control system;

FIGS. 10-12 include cross-sectional views of an example portion of the steering wheel;

FIGS. 13-14 are perspective views of an example implementation of the HOD sensor from a point of view toward a sensor metal film layer;

FIG. 15 includes an exploded perspective view of the HOD sensor;

FIG. 16 includes a cross-sectional view of the HOD sensor;

FIG. 17 is an exploded perspective view of a sensor metal layer or a shield metal layer;

FIG. 18 includes a cross-sectional view of the sensor metal layer or the shield metal layer; and

FIG. 19 includes a cross-sectional view of an example portion of the steering wheel.

In the drawings, reference numbers may be reused to identify similar and/or identical elements.

### DETAILED DESCRIPTION

Some vehicles include a steering wheel that includes a heater and a hands off detection (HOD) sensor. The heater may include one or more electrical conductors that is/are attached/sewn on a fabric or another carrier material. The electrical conductor generates heat when current flows through the heater.

The HOD sensor determines and indicates whether the hands of a driver of the vehicle are off of the steering wheel, such as during autonomous or semi-autonomous driving of the vehicle. A control module may discontinue the autonomous or semi-autonomous driving when the hands of the driver are off of the steering wheel for a predetermined period. One or more other actions may additionally or alternatively be taken when the hands of the driver are off of the steering wheel for a predetermined period. For example, one or more modules may output a visible and/or audible output indicative of the hands of the driver being off of the steering wheel when the hands of the driver are off of the steering wheel for a predetermined period.

The HOD sensor could include one or more electrical conductors that is/are attached to/sewn on a fabric or another carrier material. The HOD sensor may determine and indicate whether the hands of the driver are off of the steering wheel based on a capacitance measured using the HOD sensor and using a compensator. A parasitic capacitance of the sensor and the compensator, however, may change and may change non-linearly during temperature changes of the heater. A relatively complex compensator may be needed to accurately detect whether the hands of the driver are off of the steering wheel given the changes observed during use of the heater.

The present application involves a metalized sensor layer being disposed on a first surface of a substrate and a metalized shield layer being disposed on a second surface of the substrate that is opposite the first surface. The metalized shield layer is disposed between the metalized sensor layer and the heater layer. The metalized sensor and shield layers may be deposited on the substrate (e.g., a plastic, a foam, a fleece, etc.) via vapor deposition, such as physical vapor deposition (PVD). Examples of PVD that may be used include evaporation PVD and sputtering PVD.

The use of the metalized sensor layer and the metalized shield layer decreases parasitic capacitance variation due to temperature change and the metalized shield layer blocks switching noise of the heater. The use of the metalized shield and sensor layers eliminates the need for complex compensation and increases accuracy of hands off of steering wheel detection. Apertures or slits may be made through the metalized layers and the substrate to increase flexibility of the HOD sensor without ripping of the metalized layer(s).

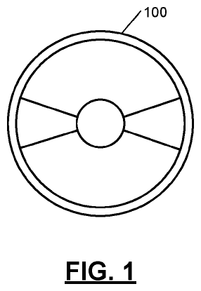

FIG. 1 shows a steering wheel 100 of a vehicle. A driver turns the steering wheel 100 to steer or turn the vehicle left and right. The steering wheel 100 is a toroid with two degrees of surface curvature.

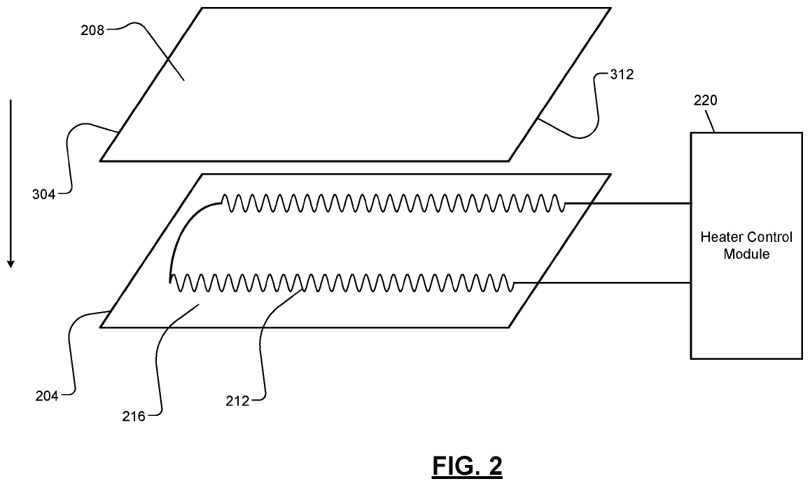

A flexible circuit comprising a heater and a hands off detection (HOD) sensor may be flat and rectangular in shape (e.g., see FIG. 2) before being applied to the steering wheel 100. The flexible circuit may be covered with a covering material, such as leather or another suitable type of material.

FIG. 2 is an exploded perspective view of the heater 204 and the HOD sensor 208 before application to the steering wheel 100. The heater 204 includes one or more electrical conductors 212. The electrical conductor(s) 212 may be, for example, woven into a fabric 216 or disposed on or in another suitable type of substrate. The electrical conductor(s) 212 form a resistive heater. A heater control module 220 controls current through the electrical conductor(s) 212. For example, the heater control module 220 may apply power to the electrical conductor(s) 212 from a battery of the vehicle. The electrical conductor(s) 212 generate(s) heat when current flows through the electrical conductor(s) 212.

The HOD sensor 208 is located radially outwardly of the heater 204 when part of the steering wheel 100. The HOD sensor 208 may be applied directly to the heater 204 in various implementations. In other implementations, one or more other materials (e.g., one or more layers of a foam) may be disposed between the HOD sensor 208 and the heater 204. The one or more other layers may, for example, improve a tactile experience (haptic) of touching the steering wheel 100.

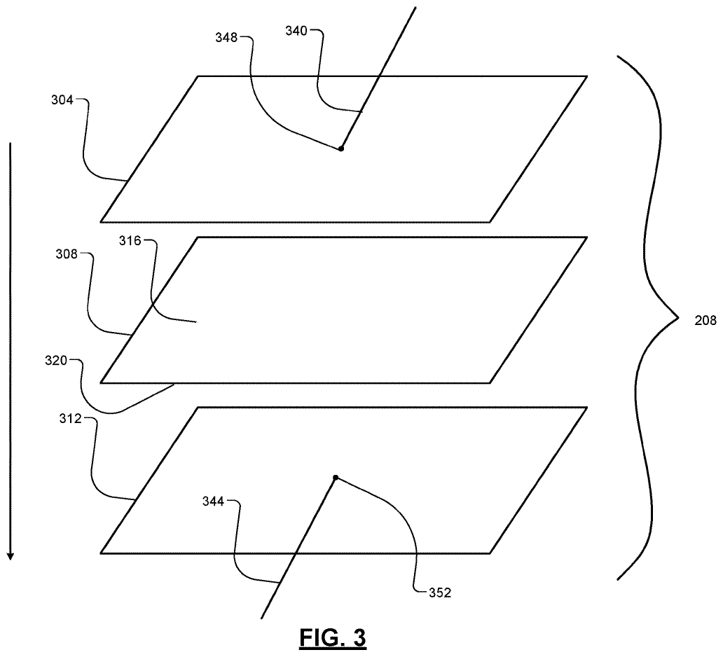

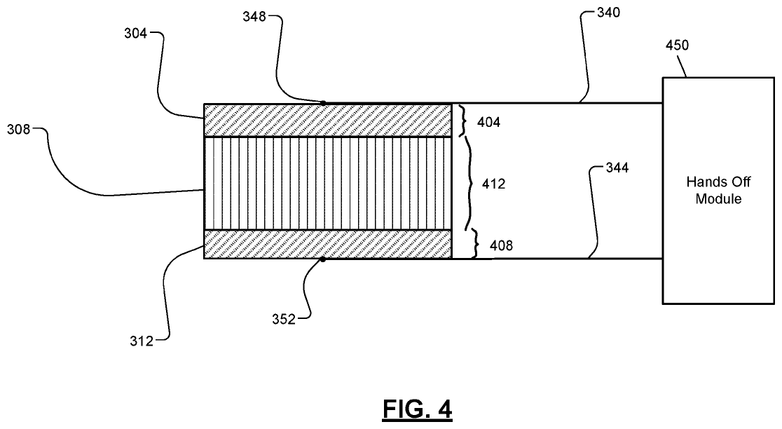

FIG. 3 includes an exploded perspective view of the HOD sensor 208. FIG. 4 includes a cross-sectional view of the HOD sensor 208. Referring to FIGS. 2-4, the HOD sensor 208 includes a sensor metal film layer 304, a substrate 308, and a shield metal film layer 312. The metal of the layers 304 and 312 may be, for example, aluminum, copper, or another suitable electrically conductive material. The substrate 308 may be, for example, polyester (PET), polyurethane, a plastic, a foam, a fleece, a polymer film, or another suitable material.

The sensor metal film layer 304 is disposed on a first face 316 of the substrate 308. The shield metal film layer 312 is disposed on a second face 320 of the substrate 308. The second face 320 is opposite the first face 316. The second face 320 faces the heater 204.

The thicknesses illustrated in FIG. 4 may not be to scale. The thickness 404 of the sensor metal film layer 304 and the thickness 408 of the shield metal film layer 312, however, are less than the thickness 412 of the substrate 308. The thicknesses 404 and 408 of the shield and metal film layers 304 and 312 may be, for example, between approximately 30 nanometers (nm) and 2 micrometers or another suitable thickness. The thickness 412 of the substrate 308 may be, for example, approximately 10-20 micrometers or another suitable thickness. The substrate 308 electrically isolates the sensor metal film layer 304 from the shield metal film layer 312.

The sensor metal film layer 304 and the shield metal film layer 312 may be disposed on the substrate 308, for example, using vapor deposition. The vapor deposition may be, for example, physical vapor deposition (PVD) or another suitable form of vapor deposition. While the example of vapor deposition is provided, the sensor and shield metal film layers 304 and 312 may be applied to the substrate 308 via lamination or in another suitable manner.

A first electrical conductor 340 (e.g., an insulated wire) is electrically connected to the sensor metal film layer 304. A second electrical conductor 344 (e.g., an insulated wire) is electrically connected to the shield metal film layer 312. The first and second electrical conductors 344 may be attached to the sensor and shield metal film layers 304 and 312, respectively, via an electrically conductive glue or adhesive or in another suitable manner as illustrated by 348 and 352.

As shown in FIG. 4, a hands off module 450 is electrically connected to the first and second electrical conductors 340 and 344 and measures a capacitance between the sensor and metal film layers 304 and 312. Touching of the steering wheel 100 changes the capacitance measured by the hands off module 450. The hands off module 450 determines and indicates whether the hands of the driver are off of the steering wheel 100 or not based on the capacitance. For example, the hands off module 450 may determine that the hands of the driver are off of the steering wheel 100 when the capacitance is less than a predetermined capacitance or decreases by at least a predetermined capacitance change.

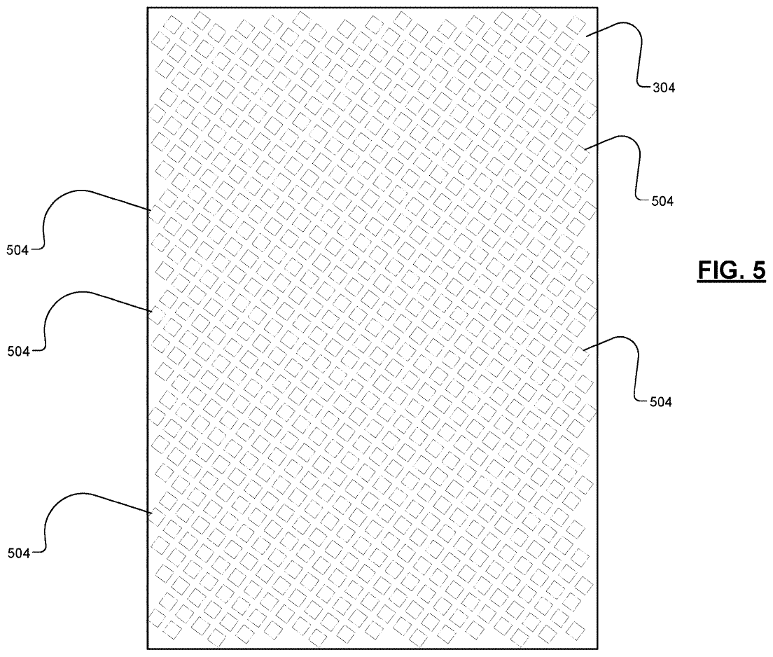

FIG. 5 is a perspective view of an example implementation of the HOD sensor 208 looking the sensor metal film layer 304. As illustrated in FIG. 5, apertures 504 may be formed through the HOD sensor 208 and extend through the sensor metal film layer 304, the substrate 308, and the shield metal film layer 312.

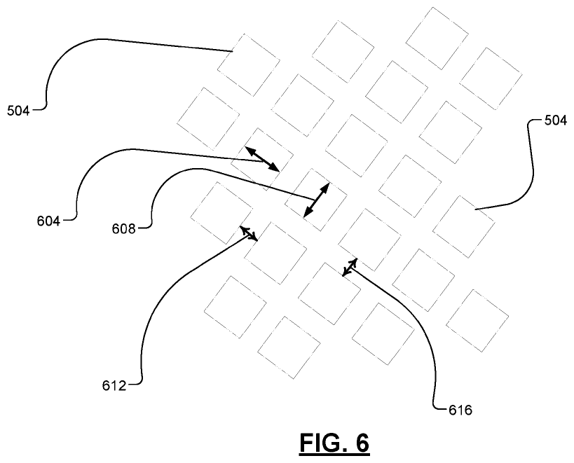

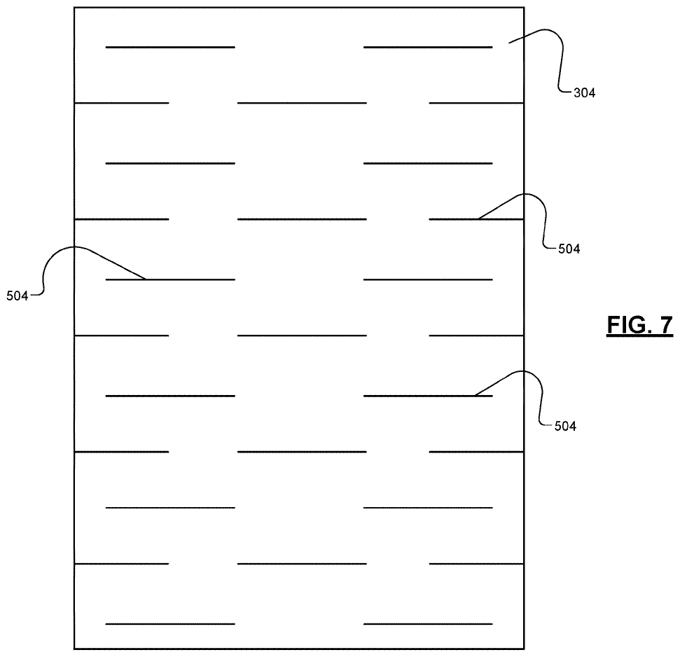

FIG. 6 is a close up perspective view of some of the apertures 504. While the example of rectangular (or square) shaped apertures is provided, the present application is also applicable to other shapes, such as triangular, circular, hexagonal, octagonal, ovular, diamond, etc. FIG. 7 is another perspective view of an example implementation of the HOD sensor 208 looking toward the sensor metal film layer 304. In the examples of FIGS. 7, 13, and 14, the apertures 504 are linear slits. The apertures 504 increase flexibility of the HOD sensor 208 and allow stretching without breaking of the metal of the metal film layers.

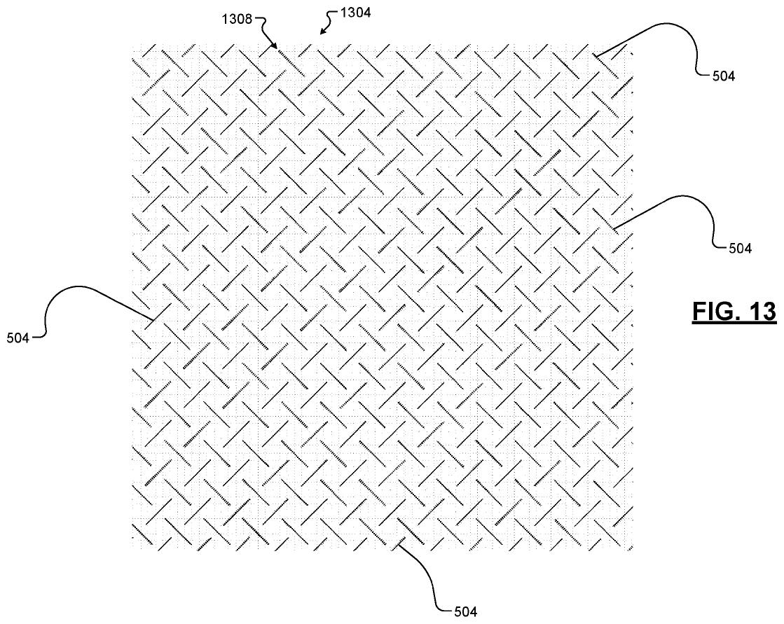

In the example of FIG. 7, the slits 504 are parallel to each other. In the example of FIG. 13, rows of slits 504 are arranged orthogonally with each slit being arranged orthogonally to 4 adjacent slits. Slits of a first row 1304 are arranged orthogonally to slits of a second row 1308, slits of other rows are parallel to the second row 1308. Also slits of other rows are parallel to the slits of the first row 1304.

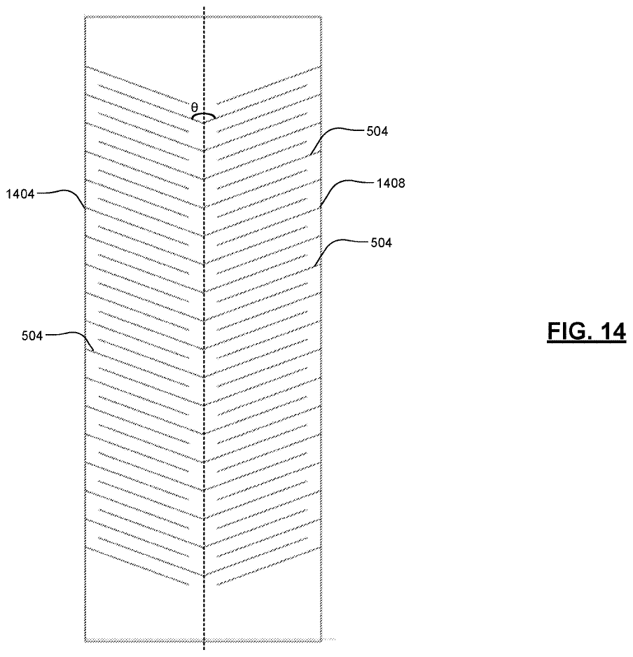

In the example of FIG. 14, the slits 504 are arranged in V-shapes and intersect and form obtuse angles θ. First edges 1404 of the slits 504 are wrapped around the steering wheel and contact second edges 1408 of the slits 504. A curve connecting the points of the V-shapes, illustrated by a dashed line in FIG. 14, forms the same shape as the steering wheel and is disposed radially outwardly of the steering wheel core 804. The slits discussed herein can be made mechanically (e.g., via knife), via laser cutting, or in another suitable manner.

The apertures 504 may each have the same dimensions, and the spacings between adjacent ones of the apertures 504 may be identical. In various implementations, the apertures 504 may include apertures with different dimensions. In various implementations, the spacings between adjacent apertures 504 may vary. In various implementations, the apertures 504 may include two or more different shapes and/or sizes.

The apertures 504 may extend to peripheral edges of the HOD sensor 208 or a border of the metal film without apertures may be included. The apertures 504 may be made, for example, by die cutting, laser cutting, punching, or in another suitable manner.

In the example of FIG. 6, a length 604 and a width 608 of the apertures 504 may be approximately 6 millimeters, 8 millimeters, or another suitable length. A first distance 612 between adjacent apertures in a first direction may be, for example, approximately 3 millimeters or another suitable length. A second distance 616 between adjacent apertures in a second direction (e.g., perpendicular to the first direction) may be equal to the first distance 612 and may be, for example, 3 millimeters or another suitable length. In various implementations the length and the width 604 and 608 of the apertures may be at least twice as large as the first distance 612 and/or twice as large as the second distance 616.

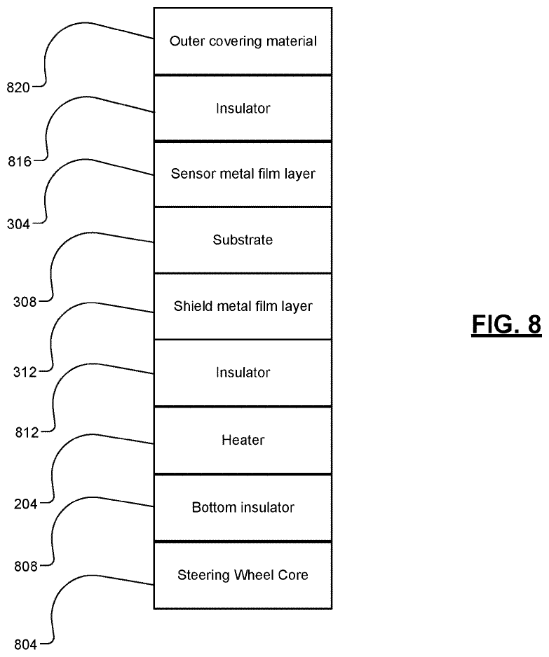

An element that is vertically upward from a second element in FIG. 8 is disposed radially outwardly of the second element. A steering wheel core 804 may be a radially inwardly most portion of the steering wheel 100. A first (bottom) electrical insulator 808 may be disposed radially outwardly of the steering wheel core 804 and may be, for example, a foam or another suitable type of electrically insulative/isolative material.

The heater 204 may be disposed radially outwardly of the first insulator 808. A second electrical insulator 812 may be disposed between the HOD sensor 208 and the heater 204. The second electrical insulator 812 may be, for example, a foam or another suitable type of electrically insulative/isolative material. The HOD sensor 208 may be disposed radially outwardly of the second insulator 812.

A third electrical insulator 816 may be disposed radially outwardly of the HOD sensor 208. The third electrical insulator 816 may be, for example, a foam or another suitable type of electrically insulative/isolative material. An outer covering material 820 is disposed radially outwardly of the third electrical insulator 816 and can be contacted by the hands of the driver. The outer covering material 820 may be, for example, leather or another suitable material. In various implementations, one or more of the layers may be adhered together, such as using one or more adhesives and/or glues. In various implementations, the second electrical insulator 812 and/or the third electrical insulator 816 may be an adhesive, such as a pressure sensitive adhesive tape.

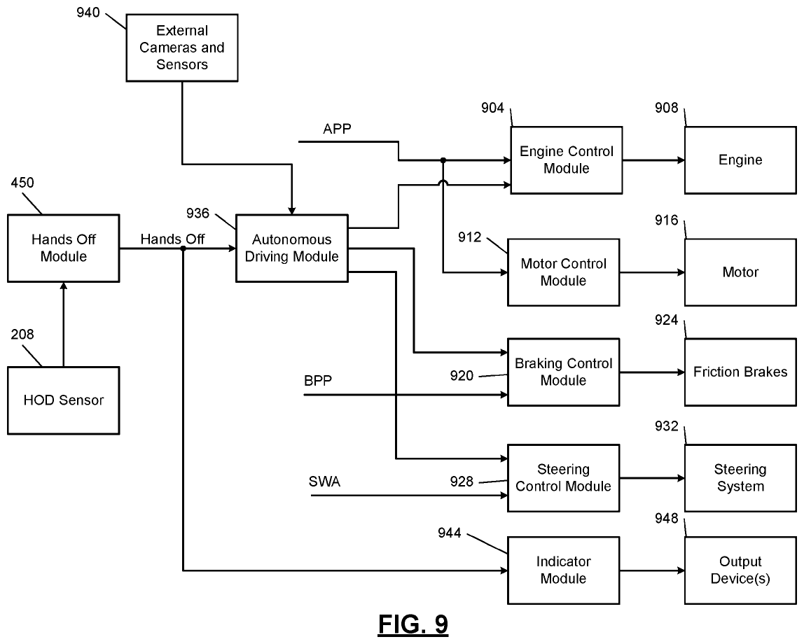

As shown in FIG. 9, an engine control module 904 may control torque output of an internal combustion engine 908 based on one or more driver inputs, such as an accelerator pedal position (APP). The engine control module 904 may control torque output of the engine by controlling one or more actuators of the engine 908. The engine 908 may transfer torque to two or more wheels of the vehicle via a transmission. In various implementations, such as in the example of pure electric vehicles, the engine 908 may be omitted.

A motor control module 912 may control torque output of electric motor 916 based on one or more of the driver inputs, such as the APP. While the example of one electric motor is provided, the vehicle may include more than one electric motor. An electric motor may output torque directly to a wheel of a vehicle or indirectly to two or more wheels of the vehicle.

A braking control module 920 controls application of friction brakes 924 of the vehicle based on a brake pedal position (BPP). Application of the friction brakes 924 slows the vehicle.

A steering control module 928 controls a steering system 932 of the vehicle to control steering and turning of the wheel. The steering control module 928 controls the steering system based on a steering wheel angle (SWA) of the steering wheel 100.

In various implementations, the engine control module 904, the motor control module 912, the braking control module 920, and/or the steering control module 928 may control the engine 908, the electric motor 916, the friction brakes 924, and the steering system 932 based on commands from an autonomous driving module 936 for autonomous or semi-autonomous driving. The autonomous driving module 936 may generate the commands based on input from one or more external cameras and/or sensors 940. Examples of external cameras and sensors include one or more forward facing cameras, one or more light detection and ranging (LIDAR) sensors, one or more radar sensors, one or more ultrasonic sensors, and/or one or more other types of sensors that sense features outside of the vehicle.

The autonomous driving module 936 may generate one or more commands for the engine control module 904, the motor control module 912, and/or the braking control module 920, for example, to accelerate or decelerate the vehicle during autonomous or semi-autonomous driving (e.g., to maintain a predetermined following distance, etc.). The autonomous driving module 936 may generate a command for the steering control module 928, for example, to accelerate or decelerate steering the vehicle rightward or leftward (e.g., for object avoidance, lane maintenance, route following, etc.).

When the hands off module 450 detects that the hands of the driver are off of the steering wheel 100 using the HOD sensor 208, one or more actions may be taken. For example, the autonomous driving module 936 may end the autonomous or semi-autonomous driving when the hands off module 450 detects that the hands of the driver are off of the steering wheel 100 (e.g., for a predetermined period). The engine control module 904, the motor control module 912, the braking control module 920, and/or the steering control module 928 may then control the engine 908, the electric motor 916, the friction brakes 924, and the steering system 932 based on, for example, the APP, the BPP, and the SWA as described above. The autonomous driving module 936 may allow autonomous or semi-autonomous driving to continue when the hands off module 450 detects that the hands of the driver are on of the steering wheel 100 using the HOD sensor 208.

When the hands off module 450 detects that the hands of the driver are off of the steering wheel 100 using the HOD sensor 208, an indicator module 944 may output one or more indicators via one or more output devices 948 of the vehicle. Examples of output devices include displays, lights, speakers, haptic (vibrating) devices, and other devices within the passenger cabin of the vehicle. For example, when the hands off module 450 detects that the hands of the driver are off of the steering wheel 100, the indicator module 944 may output an audible indicator via one or more speakers, a visual indicator via one or more displays and/or lights, and/or output a haptic indicator via one or more haptic devices.

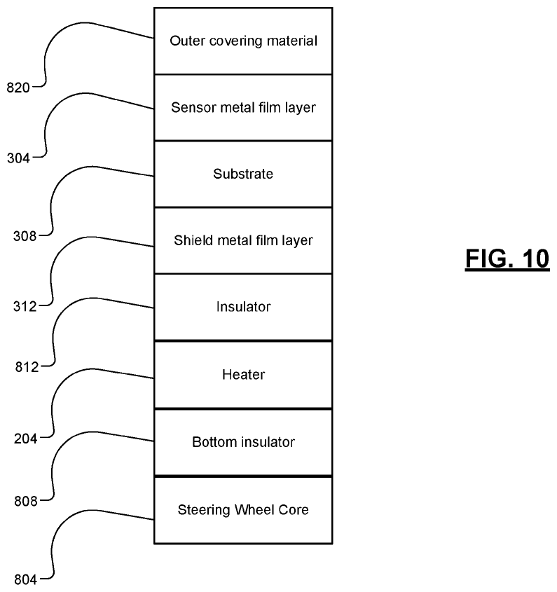

FIGS. 10-12 include cross-sectional views of example portions of the steering wheel. As shown in FIG. 10, the insulator 816 may be omitted. In the example of FIG. 10, the sensor layer 304 and the shield layer 312 are disposed radially outwardly of the heater 204.

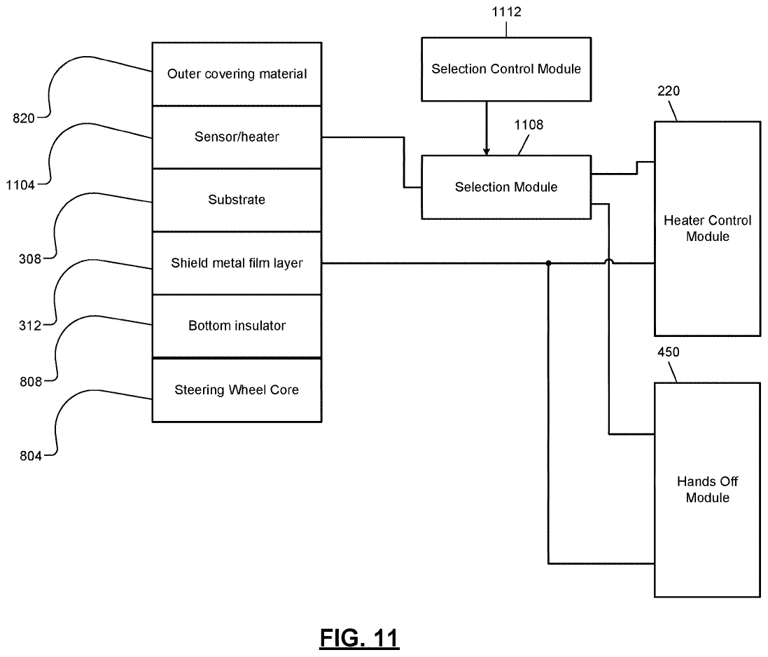

In the example of FIG. 11, a combination sensor/heater 1104 may be included. The sensor/heater 1104 may include electrically conductive wire or a metal layer as described above. A selection module 1108 may connect either the heater control module 220 or the hands off module 450 to the sensor/heater 1104 at any given time. The heater control module 220 applies power to the sensor/heater 1104 when the heater control module is connected to the sensor/heater 1104 via the selection module 1108. The sensor/heater 1104 then generates heat. When the hands off module 450 is connected to the sensor/heater 1104 via the selection module 1108 measures via the sensor/heater 1104.

The selection module 1108 selects to connect either the heater control module 220 or the hands off module 450 based on a state of a signal from a selection control module 1112. For example, the selection module 1108 may connect the heater control module 220 to the sensor/heater 1104 when the signal is in a first state. The selection module 1108 may connect the hands off module 450 to the sensor/heater 1104 when the signal is in a second state. The selection control module 1112 may in various implementations toggle the signal back and forth between the first state and the second state. For example, the selection control module 1112 may set the signal to the first state for a predetermined period then toggle the signal to the second state, set the signal to the second state for a predetermined period then toggle signal back to the first state, etc. The present application, however, is also applicable to setting the signal in another suitable manner.

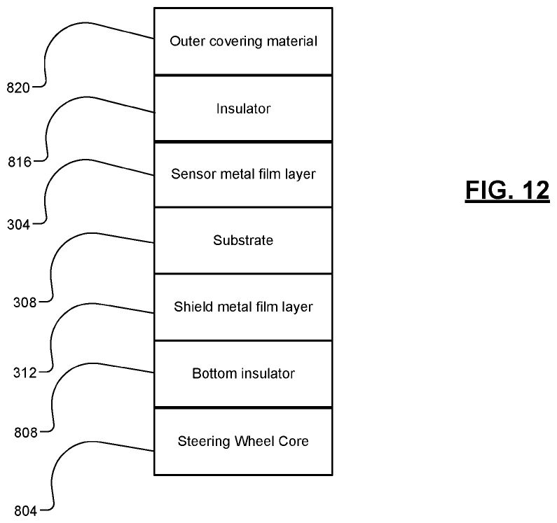

As illustrated in FIG. 12, the heater 204 may be omitted.

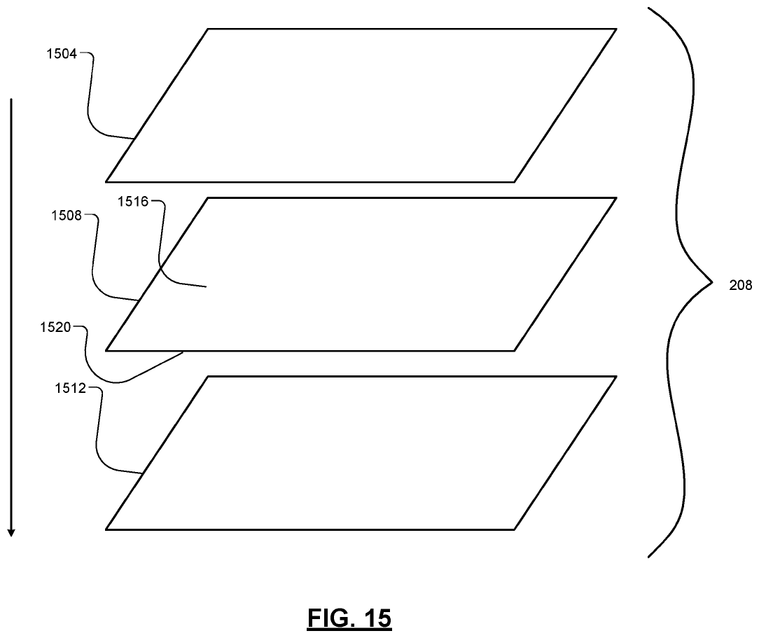

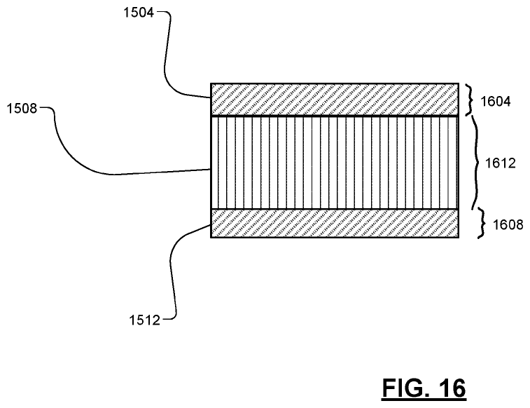

FIGS. 15-16 illustrate an example of the HOD sensor 208. FIG. 15 includes an exploded perspective view of the HOD sensor 208. FIG. 16 includes a cross-sectional view of the HOD sensor 208. Referring to FIGS. 15-16, the HOD sensor 208 includes a sensor metal layer 1504, a substrate 1508, and a shield metal layer 1512. The substrate 1508 may be, for example, polyester (PET), polyurethane, a plastic, a foam (e.g., polyethylene foam), a fleece, a polymer film, or another suitable material.

The sensor metal layer 1504 is disposed on a first face 1516 of the substrate 1508. The shield metal layer 1512 is disposed on a second face 1520 of the substrate 1508. The second face 1520 is opposite the first face 1516. The second face 1520 faces the heater 204.

The thicknesses illustrated in FIG. 16 may not be to scale. The thickness 1604 of the sensor metal layer 1504 and the thickness 1608 of the shield metal layer 1512, however, are less than the thickness 1612 of the substrate 1508. The thicknesses 1604 and 1608 of the shield and metal layers 1504 and 1512 may be, for example, between approximately 1 micrometer and 30 micrometers, such as approximately 25 micrometers, or another suitable thickness. The thickness 1612 of the substrate 1508 may be, for example, approximately 0.1-1 millimeters, such as approximately 0.55 mm, or another suitable thickness. The substrate 1508 electrically isolates the sensor metal layer 1504 from the shield metal layer 1512.

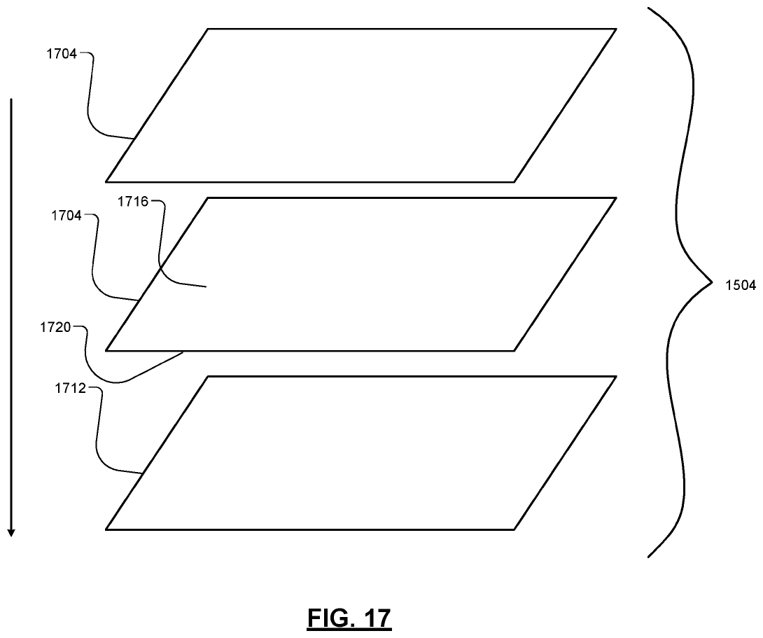

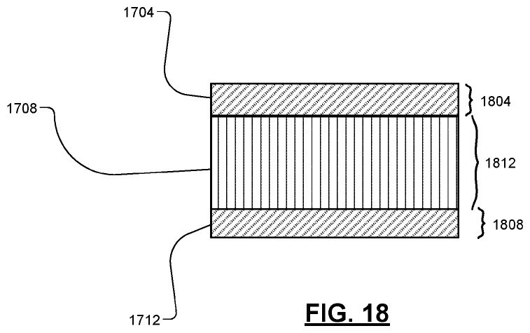

FIG. 17 is an exploded perspective view of the sensor metal layer 1504. FIG. 18 includes a cross-sectional view of the sensor metal layer 1504. The shield metal layer 1512 may be the same as the sensor metal layer 1504 as illustrated in FIGS. 17 and 18.

The sensor metal layer 1504 includes a first metal film layer 1704, a substrate 1708, and a second metal film layer 1712. The metal of the layers 1704 and 1712 may be, for example, aluminum, copper, or another suitable electrically conductive material. The substrate 308 may be, for example, polyester (PET), polyurethane, a plastic, a foam, a fleece, a polymer film, or another suitable material.

The first metal film layer 1704 is disposed on a first face 1716 of the substrate 1708. The second metal film layer 1712 is disposed on a second face 1720 of the substrate 1708. The second face 1720 is opposite the first face 1716. The second face 320 faces the substrate 1508.

The thicknesses illustrated in FIG. 18 may not be to scale. The thickness 1804 of the first metal film layer 1704 and the thickness 1808 of the second metal film layer 1712, however, are less than the thickness 1812 of the substrate 1708. The thicknesses 1804 and 1812 of the first and second metal film layers 1704 and 1712 may be, for example, between approximately 10 micrometers to 40 micrometers, such as 25 micrometers, or another suitable thickness. The thickness 1812 of the substrate 1708 may be, for example, approximately 0.4 millimeters to 0.7 millimeters, such as 0.55 millimeters, or another suitable thickness. The substrate 1708 electrically isolates the first metal film layer 1704 from the second metal film layer 1712.

The first metal film layer 1704 and the second metal film layer 1712 may be disposed on the substrate 1708, for example, using vapor deposition. The vapor deposition may be, for example, PVD or another suitable form of vapor deposition. While the example of vapor deposition is provided, the first and second metal film layers 1704 and 1712 may be applied to the substrate 1708 via lamination or in another suitable manner.

A first electrical conductor (e.g., an insulated wire) may be connected to the first metal film layer 1704 of the sensor metal layer 1504. In various implementations, a second electrical conductor (e.g., an insulated wire) may be connected to the second metal film layer 1712 of the sensor metal layer 1504. A third electrical conductor (e.g., an insulated wire) may be electrically connected to the first metal film layer 1704 of the shield metal layer 1512. A fourth electrical conductor (e.g., an insulated wire) may be electrically connected to the second metal film layer 1712 of the shield metal layer 1512. The electrical conductors may be attached to the sensor and shield metal layers, respectively, via an electrically conductive glue or adhesive or in another suitable manner. In various implementations, only one electrical conductor may be connected to one of the metal film layers of the shield metal layer 1504, and one electrical conductor may be connected to one of the metal film layers of the shield metal layer 1512.

The hands off module 450 is electrically connected to and measures a capacitance between the metal film layers 1504 and 1512. Touching of the steering wheel 100 changes the capacitance measured by the hands off module 450. The hands off module 450 determines and indicates whether the hands of the driver are off of the steering wheel 100 or not based on the capacitance. For example, the hands off module 450 may determine that the hands of the driver are off of the steering wheel 100 when the capacitance is less than a predetermined capacitance or decreases by at least a predetermined capacitance change.

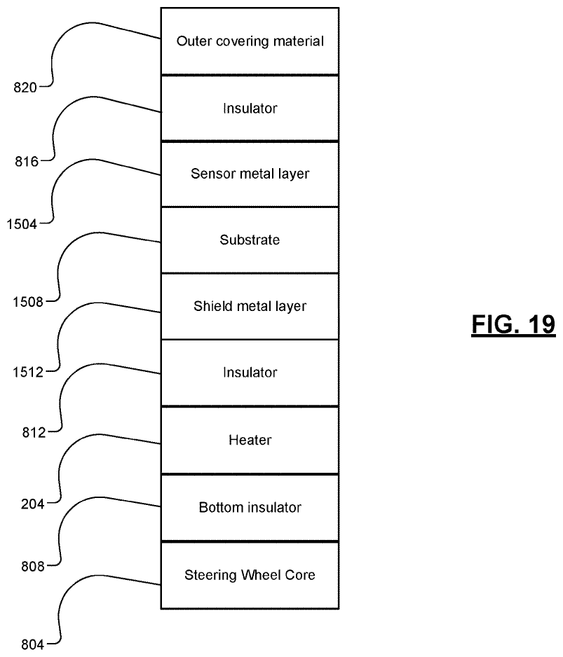

FIG. 19 is a cross-sectional view of an example portion of the steering wheel. As illustrated, the shield metal layer 1512 may be disposed radially outwardly of the insulator 812. The substrate 1508 may be disposed radially outwardly of the shield metal layer 1512. The sensor metal layer 1504 may be disposed radially outwardly of the substrate 1508 and radially inwardly of the insulator 816. The sensor metal layer 1504 and the shield metal layer 1512 may be as describe in conjunction with FIGS. 16-18.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A hands off detection (HOD) sensor of a steering wheel of a vehicle, the HOD sensor comprising:
an electrically insulative substrate having a first surface and a second surface that is opposite the first surface;
a first metal layer disposed on the first surface of the electrically insulative substrate; and
a first electrical conductor having a first end that is directly electrically connected to the first metal layer,
wherein the first metal layer is attached to the first surface of the electrically insulative substrate without an adhesive; and
a plurality of apertures that extend through the electrically insulative substrate, the first metal layer, and the second metal layer,
wherein the apertures include at least two different sizes.

2. The HOD sensor of claim 1 wherein the first metal layer is a first metal film layer.

3. The HOD sensor of claim 2 further comprising:
a second metal film layer disposed on the second surface of the electrically insulative substrate; and
a second electrical conductor having a first end that is directly electrically connected to the second metal film layer.

4. The HOD sensor of claim 3 wherein the first and second metal film layers are layers of aluminum film.

5. The HOD sensor of claim 3 wherein the first and second metal film layers are layers of copper film.

6. The HOD sensor of claim 1 wherein the electrically insulative substrate includes one of polyester, polyurethane, and a polymer film.

7-9. (canceled)

10. The HOD sensor of claim 1 wherein the apertures all have the same shape.

11. The HOD sensor of claim 1 claim wherein the apertures include at least two different shapes.

12. The HOD sensor of claim 1 wherein spacing between adjacent ones of the apertures is the same.

13. The HOD sensor of claim 1 wherein spacing between adjacent ones of the apertures includes at least two different spacings.

14. The HOD sensor of claim 3 wherein the first end of the first electrical conductor is adhered to the first metal film layer and the first end of the second electrical conductor is adhered to the second metal film layer.

15. The HOD sensor of claim 3 further comprising one of electrically conductive adhesive and electrically conductive glue that adheres the first end of the first electrical conductor to the first metal film layer and the first end of the second electrical conductor is adhered to the second metal film layer.

16. The HOD sensor of claim 3 wherein a first thickness of the first metal film layer and a second thickness of the second metal film layer are less than a third thickness of the electrically insulative substrate.

17. The HOD sensor of claim 16 wherein the first and second thicknesses are less than 2 micrometers.

18. The HOD sensor of claim 16 wherein the first and second thicknesses are less than 1 micrometer.

19. The HOD sensor of claim 16 wherein the first and second thicknesses are less than 0.5 micrometers.

20. The HOD sensor of claim 3 wherein the first metal film layer and the second metal film layer are deposited on the electrically insulative substrate using vapor deposition.

21. The HOD sensor of claim 20 wherein the vapor deposition is physical vapor deposition.

22. A steering wheel, comprising:
the HOD sensor of claim 3; and
an electric heater,
wherein the second metal film layer is disposed radially between the first metal film layer and the electric heater.

23. The steering wheel of claim 22 further comprising an electrical insulator disposed between the second metal film layer and the electric heater.

24. The steering wheel of claim 23 wherein the electrical insulator is a foam.

25. A system comprising:
the HOD sensor of claim 3; and
a hands off module configured to:
electrically connect to second ends of the first and second electrical conductors; and
detect when a driver's hands are off of the steering wheel based on a capacitance between the first and second metal film layers.

26. The HOD sensor of claim 3 wherein the first and second electrical conductors are insulated electrical conductors.

27. A hands off detection (HOD) sensor of a steering wheel of a vehicle, the HOD sensor comprising:
an electrically insulative substrate having a first surface and a second surface that is opposite the first surface;
a first metal layer disposed on the first surface of the electrically insulative substrate; and
a second metal layer disposed on the second surface of the electrically insulative substrate,
wherein each of the first metal layer and the second metal layer includes:
a second electrically insulative substrate having a third surface and a fourth surface that is opposite the third surface;
a first metal film layer disposed on the third surface; and
a second metal film layer disposed on the fourth surface.

28. The HOD sensor of claim 27 wherein a first thickness of the second electrically insulative substrate is greater than a second thickness of the first metal film layer and greater than a third thickness of the second metal film layer.

29. The HOD sensor of claim 27 wherein the first metal film layer and the second metal film layer are deposited on the second electrically insulative substrate using vapor deposition.

30. The HOD sensor of claim 29 wherein the vapor deposition is physical vapor deposition.

31. The HOD sensor of claim 27 further comprising linear slits through the first electrically insulative substrate, the first metal layer, and the second metal layer.

32. The HOD sensor of claim 31 wherein the linear slits are arranged in a V-shape.

33. The HOD sensor of claim 31 wherein the linear slits include first rows of linear slits that are parallel and second rows of linear slits that form orthogonal angles with the linear slits of the first rows.

34. The HOD sensor of claim 27 wherein a first thickness of the a second electrically insulative substrate is greater than a second thickness of the first metal film layer and a third thickness of the second metal film layer.

35. The HOD sensor of claim 27 wherein the second electrically insulative substrate is made of polyester, and the first and second metal film layers include aluminum.
